(19) United States
(12) Patent Application Publication
(10) Pub. No.: US 2011/0186244 A1
(43) Pub. Date: Aug. 4, 2011

(54) COMPOSITE BLIND SLAT AND METHOD OF MAKING THE SAME

(75) Inventor: Shih-Chang Huang, Fusing Township (TW)

(73) Assignee: TAICANG KINGFU PLASTIC MANUFACTURE CO., LTD., Taicang (CN)

(21) Appl. No.: 12/844,315

(22) Filed: Jul. 27, 2010

(30) Foreign Application Priority Data
Jan. 29, 2010 (CN) 201010110723.9

(51) Int. Cl. E06B 9/386; B29C 51/02

(52) U.S. Cl. 160/236; 264/137

(57) ABSTRACT

A composite blind slat is made by impregnating a pulp fiber web with an aqueous dispersion that contains styrene-octylacrylate copolymer, and water, followed by thermal forming the impregnated pulp fiber web. The aqueous dispersion has a high penetrating ability to penetrate the pulp fiber web. The composite blind slat is environmentally friendly and can be made from waste paper pulp.

### CROSS-REFERENCE TO RELATED APPLICATION

This application claims priority of Chinese Patent Application No. 201010110723.9 filed on Jan. 29, 2010.

### BACKGROUND OF THE INVENTION

1. Field of the Invention

The invention relates to a Venetian blind, more particularly to a composite blind slat for a Venetian blind, and a method of making the blind slat.

2. Description of the Related Art

Early blind slats are made from thin metal plates, such as by forming thin aluminum or ion plates into curved plates of arcuate cross-section, followed by coating the surfaces of the curved plates. Such metallic blind slats are expansive, heavy, and inconvenient and have poor thermal insulation properties. In order to address the drawbacks of the metallic blind slats, the metallic blind slats have been replaced by plastic slats, such as PVC slats which are lighter and are easier to operate. However, as PVC can not be recycled and decomposed biologically, it is an increasing trend to prohibit PVC products in most countries in the world. Many attempts have been made to seek environment conserving substitutes for PVC blind slats. For example, the applicant of the present invention proposed a method of making blind slats using recycled fly ash as a major material. However, the fly ash blind slats are not widely accepted as they are heavy and inconvenient to handle. Therefore, there is a need of blind slats that are environmentally friendly and that can be handled conveniently.

### SUMMARY OF THE INVENTION

Therefore, the main object of the present invention is to provide a light weight composite blind slat that is made from an environmentally friendly pulp fiber web.

Another object of the present invention is to provide a method of making the composite blind slat.

According to one aspect of the present invention, a composite blind slat comprises: a pulp fiber web; and a styrene octylacrylate copolymer impregnating and reinforcing the pulp fiber web.

According to another aspect of the present invention, a method of making a blind slat comprises: providing a pulp fiber web; impregnating the pulp fiber web with an aqueous dispersion that contains a styrene-octyl acrylate copolymer, and water; and thermal forming the pulp fiber web that has been impregnated.

### BRIEF DESCRIPTION OF THE DRAWINGS

Other features and advantages of the present invention will become apparent in the following detailed description of the preferred embodiments with reference to the accompanying drawings, of which:

FIG. 1 is a flow diagram illustrating a method of making composite blind slats according to a preferred embodiment of the present invention;

FIG. 2 is a schematic view illustrating an apparatus for making composite blind slats according to a preferred embodiment of the present invention;

FIG. 3 is a schematic view showing an impregnation tank of the apparatus of FIG. 2;

FIG. 4 is a schematic view showing a forming channel of the apparatus of FIG. 2;

FIG. 5 is a perspective view of the composite blind slat made by the present invention; and

FIG. 6 is a sectional view of the composite blind slat of FIG. 5.

### DETAILED DESCRIPTION OF THE PREFERRED EMBODIMENTS

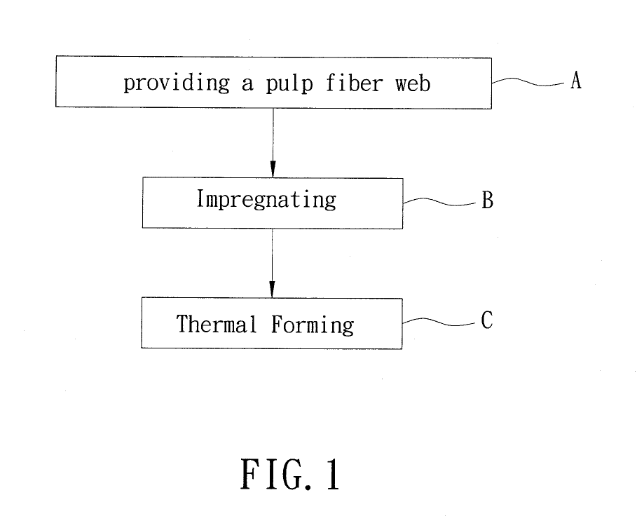

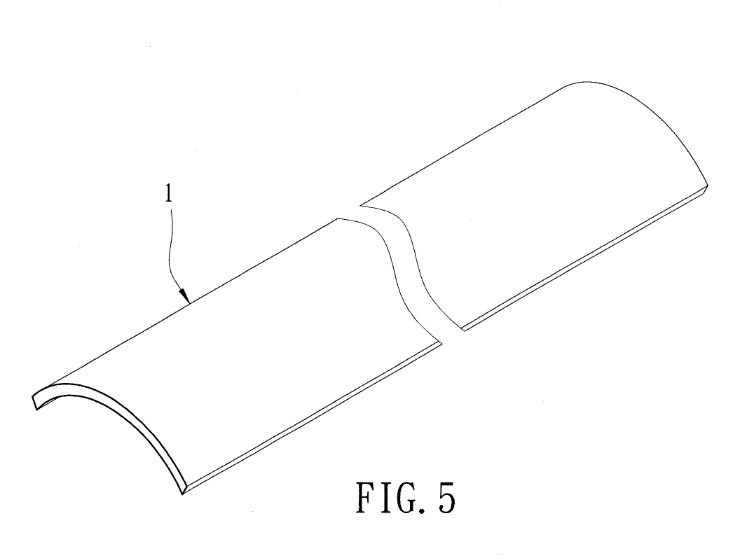

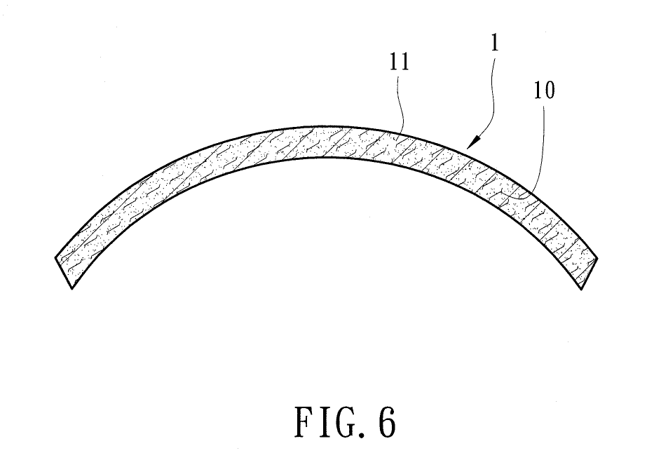

Referring to FIGS. 1, 5 and 6, a method of making a composite blind slat 1 according to the present invention includes: (A) providing a pulp fiber web; (B) impregnating the pulp fiber web with an aqueous dispersion that contains styrene-octyl acrylate copolymer, and water; and (C) thermal forming the pulp fiber web that has been impregnated.

The composite blind slat 1 includes a pulp fiber web 10, and a polyacrylate resin 11 impregnating the pulp fiber web 10.

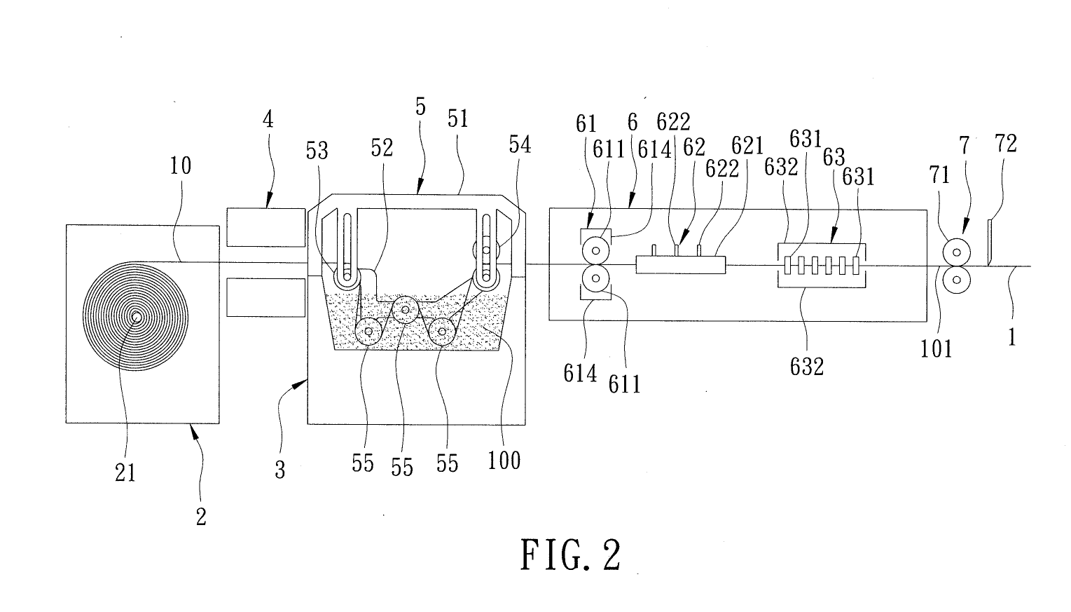

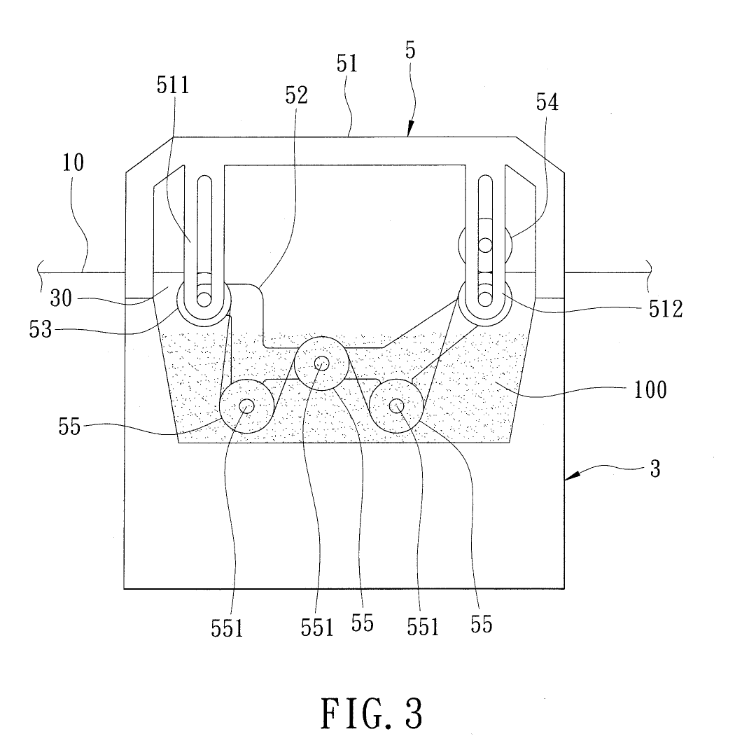

Referring to FIGS. 2, 3 and 4, there is shown an apparatus for making the composite blind slats 1 according to the present invention. The apparatus includes a feeding unit 2, an impregnation tank 3, a heating unit 4, an advancing roller assembly 5, a thermal forming unit 6, and a cutting unit 7. In a preferred embodiment, the apparatus is used to conduct the method according to the present invention. The apparatus and the method are described hereinafter.

The feeding unit 2 has a reel 21 mounted on a frame (not shown), and a continuous pulp fiber web 10 is wound around the reel 21. The pulp fiber web 10 may be made from any pulp commonly used in making paper, such as ground wood pulp, chemical pulp, semi-chemical pulp, or a waste paper pulp recycled from waste paper. Preferably, the pulp fiber web 10 is made from the waste paper pulp so that waste paper can be recycled. The thickness of the pulp fiber web 10 is preferably 0.5-5 mm.

The conveying roller assembly 5 is disposed in the impregnation tank 3 downstream of the feeding unit 2. The impregnation tank 3 contains an impregnating liquid 100 for impregnating the pulp fiber web 10. The impregnation tank 3 has a mount 51 that is disposed on top of the impregnation tank 3 and that has two downwardly extending hanging arms 511, 512, and a roller frame 52 having two ends hung on the hanging arms 511, 512 of the mount 51 and extending into the impregnating liquid 100.

The conveying roller assembly 5 has a draw roll 53 connected to the hanging arm 511 and the roller frame 52, a pair of squeeze rolls 54 connected to the hanging arm 512 and the roller frame 52, and three guide rolls 55 attached to the roller frame 52. The draw roll 53 is proximate to an upstream side of the impregnation tank 3, and the squeeze rolls 54 are proximate to a downstream side of the impregnation tank 3.

The pulp fiber web 10 from the feeding unit is passed through the heating unit 4, and the conveying roller assembly 5 directs the pulp fiber web 10 into the impregnation tank 3 where the pulp fiber web 10 is immersed in the impregnating liquid 100.

The impregnating liquid 100 includes an aqueous dispersion that includes styrene octylacrylate copolymer and water in a predetermined ratio. The aqueous dispersion of the impregnating liquid 100 has high permeating properties so that, when the pulp fiber web 10 is immersed in the impregnating liquid 100, the aqueous dispersion can readily penetrate the pores of the pulp fiber web 10. In an example, the impregnating liquid 100 is prepared by mixing water with a styrene octylacrylate copolymer which is a commercial product, DM-346, manufactured by Nan Pao Resins Chemical Co., Ltd. The specification of DM-346 is shown in Table 1.

TABLE 1

| | |
|---|---|
| Appearance | milk white |
| Viscosity* | 20-100 cps |
| pH value | 6.0-7.0 |
| Solid content | 45 ± 2% |
| Composition | Styrene-octylacrylate |
| | copolymer emulsion |

Note:
Viscosity* is measured by a method using an LVT type viscometer, No. 2 shaft, a speed of 60 r.p.m. and a temperature below 25° C.

The styrene-octylacrylate copolymer has the following properties: (1) The copolymer has a low average molecular weight and strong penetrating ability, and can penetrate uniformly into the pulp fiber web 10 so that no shell-like surface resin phenomenon occurs; (2) The copolymer has excellent adhesion to the pulp fiber web 10 and thus can provide the impregnated pulp fiber web 10 with high stiffness sufficient to prevent the blind slats formed from the impregnated pulp fiber web from slacking; (3) The copolymer permits the impregnated pulp fiber web 10 to be dyed or colored readily and uniformly without incurring uneven dying problem; (4) The copolymer is cheap and the properties thereof is comparable with those of melamine resin; and (5) The copolymer does not contain formalin and thus is safe and has low toxicity.

The ratio of styrene-octylacrylate copolymer to water in the impregnation liquid 100 can be adjusted according to a desired level of impregnation, and may range from 0.5/1 to 5/1. If it is necessary to increase further the penetrating ability of the impregnation liquid 100, a predetermined amount of isopropanol may be added to the mixture of styrene octylacrylate copolymer and water.

After the pulp fiber web 10 is immersed until it is saturated with the impregnating liquid 100, the impregnated pulp fiber web 10 is passed between the squeeze rolls 54 where excessive liquid is removed from the impregnated pulp fiber web 10. While impregnation is carried out by immersion in this embodiment, it is possible to use other impregnation methods, such as by spraying or applying the impregnating liquid 100 to the pulp fiber web 10 repeatedly until the pulp fiber web 10 is saturated with the impregnating liquid 100.

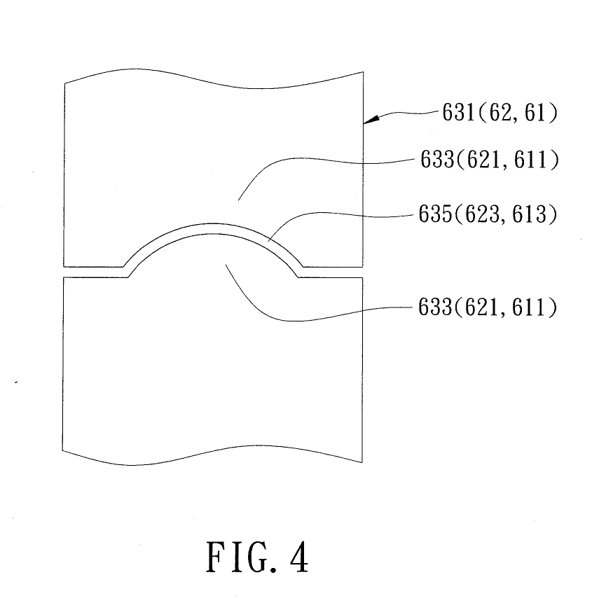

The thermal forming unit 6 is disposed downstream of the impregnation tank 3 and is used to form the pulp fiber web 10 that has been impregnated in the impregnation tank 3. The thermal forming section 6 includes a pre-forming device 61, a main forming device 62, and a post-forming device 63. Referring to FIG. 4 in combination with FIG. 2, the pre-forming device 61 has a pair of forming rollers 611, and a set of pre-heaters 614 to heat the forming rollers 611, 612. The main forming device 62 has a pair of mold halves 621, and a plurality of heating elements 622. The post-forming device 63 has a series of forming molds 631 arranged at intervals, and upper and lower heaters 632 to heat the forming molds 631. Each of the forming molds 631 has upper and lower mold halves 633.

Referring once again to FIGS. 1 and 4, the forming rollers 611 of the pre-forming device 61, the mold halves 621 of the main forming device 62, or the mold halves 633 of each forming mold 631 of the post-forming device 63 define therebetween a forming channel 613, 623 or 635 for forming the impregnated pulp fiber web 10. The forming channels 613, 623 and 635 are arcuate in cross section and are aligned with each other along the advancing direction of the pulp fiber web 10.

In the thermal forming unit 6, the impregnated pulp fiber web 10 exiting from the squeeze rolls 54 is heated and formed by the pre-forming device 61, the main forming device 62 and the post-forming device 63. Since the impregnated pulp fiber web 10 is passed through the arcuate forming channels 613, 623 and 635, it is formed into a continuous blank web 101 having an arcuated cross section. In an embodiment, the temperature used in the thermal forming unit 6 is in the range of 130-150° C., and the duration is about 5-8 min. The continuous blank web 101 has a predetermined structural strength and stiffness and therefore is not easily deformed.

The cutting section 7 is disposed downstream of the thermal forming unit 6, and includes a set of advancing rollers 71, and a cutter 72. The continuous blank web 101 is fed to the cutter 72 by the advancing rollers 71 and is cut at predetermined intervals to form a plurality of the blind slats 1.

In order to increase the function of the composite blind slat 1, one or more functional materials may be added to the impregnating liquid 100 in the impregnation tank, or added to the pulp fiber web 10 during the preparation of the pulp fiber web 10. The functional materials may include an ultraviolet ray-resisting agent, a flame-retarding agent, etc. When the ultraviolet ray-resisting agent is added, the durability of the composite blind slat 1 can be increased. The flame-retarding agent can reduce flammability of the composite blind slat 1.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method of making a composite blind slat, comprising:
providing a pulp fiber web;
impregnating the pulp fiber web with an aqueous dispersion that contains a styrene-octyl acrylate copolymer, and water; and
thermal forming the pulp fiber web that has been impregnated.

2. The method of claim 1, wherein the pulp fiber web is impregnated by immersing the pulp fiber web in the aqueous dispersion.

3. The method of claim 1, wherein the pulp fiber web is impregnated by spraying or applying the aqueous dispersion to the pulp fiber web.

4. The method of claim 1, further comprising the step of adding to the aqueous dispersion or the pulp paper web a functional material which is selected from the group consisting of an ultraviolet ray-resisting agent, a flame-retarding agent, and a combination thereof.

5. The method of claim 4, wherein the functional material is added to the aqueous dispersion.

6. The method of claim 4, wherein the functional material is added to the pulp fiber web.

7. The method of claim 1, wherein the ratio of styrene-octyl acrylate copolymer and water ranges from 0.5/1 to 5/1.

8. The method of claim 1, wherein the aqueous dispersion further contains isopropanal.

9. A composite blind slat comprising:
a pulp fiber web; and
a styrene-octylacrylate copolymer impregnating and reinforcing the pulp fiber web.

10. The composite blind slat of claim 9, wherein the pulp fiber web has a thickness ranging from 0.5-5 mm.

11. The composite blind slat of claim 9, wherein the pulp fiber web includes waste paper pulp fiber.
